(19) United States
(12) Patent Application Publication
(10) Pub. No.: US 2017/0243514 A1
(43) Pub. Date: Aug. 24, 2017

(54) Process for generating a portion profile based on user queries

(71) Applicant: Aileen Thomas, Palo Alto, CA (US)

(72) Inventor: Aileen Thomas, Palo Alto, CA (US)

(21) Appl. No.: 15/362,482

(22) Filed: Nov. 28, 2016

Related U.S. Application Data
(60) Provisional application No. 62/297,850, filed on Feb. 20, 2016.

(51) Int. Cl. G09B 19/00; G06F 17/30

(52) U.S. Cl. CPC G09B 19/0092; G06F 17/30705; G06F 17/30702; G06F 17/30637

(57) ABSTRACT

A process, comprising steps: (a) providing a list of user queries, wherein the list of user queries includes a weight query, an age query, and a physical activity query, wherein the physical activity query comprises a plurality of activity levels including sedentary, moderate, and heavy; (b) determining a metabolic factor based on the list of user queries, wherein the metabolic factor comprises building, balancing, and extra building each having a different ratio of macronutrient categories of carbohydrates, proteins, and fats; and (c) generating a Portions Profile based on the list of user queries and the metabolic factor, wherein a Portions Profile comprises a daily recommend amount of protein, carbohydrates, fats, and fluids to promote metabolic healing.

### CROSS-REFERENCE TO RELATED APPLICATIONS

The present application claims priority to U.S. Provisional Patent Application Ser. No. 62/297,850, filed on Feb. 20, 2016 entitled “Process for generating a portions profile based on user queries”, the disclosure of which is hereby incorporated in its entirety at least by reference.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Field of the Invention

The present invention relates to a process for generating a portions profile based on user queries.

Background of the Invention

Metabolic damage is a serious and insidious lifestyle-induced state of disease that can severely impact a person's quality of life and, in advanced stages, can be life-threatening. “Lifestyle-induced” means metabolic damage is the result of an individual's daily habits, a primary influencer being a diet of poor-quality food heavy in chemical additives.

Symptoms of metabolic damage are often conditions thought to be “stand-alone” illnesses that include but are not limited to unhealthy (under/over) weight, abnormal cholesterol, high blood pressure, low energy, irritability, poor sleep, skin conditions, chronic pain unrelated to injury, digestive disorders, allergies, osteoarthritis, obesity, insulin resistance, type II diabetes, osteoporosis, and certain types of cancer.

Without intervention, metabolic damage worsens over time. Because metabolic damage is lifestyle-induced, it can be healed through changes in both what and how an individual eats. That is, while eating quality food is critical, it is not the only factor. Knowing how much of what to eat, and in what combinations, is essential for metabolic healing.

### BRIEF SUMMARY OF THE INVENTION

In one embodiment of the present invention a process is provided, comprising steps: (a) providing a list of user queries, wherein the list of user queries includes a weight query, an age query, and a physical activity query, wherein the physical activity query comprises a plurality of activity levels including sedentary, moderate, and heavy; (b) determining a metabolic factor based on the list of user queries, wherein the metabolic factor comprises building, balancing, and extra building, each factor having a different ratio of macronutrient categories of carbohydrates, proteins, and fats; and (c) generating a Portions Profile based on the list of user queries and the metabolic factor, wherein a Portions Profile comprises recommended daily amounts of protein, carbohydrates, fats, and fluids to promote metabolic healing.

In one embodiment, in step (a), the weight query includes a current weight query value and ideal weight query value. In one embodiment, in step (b), building comprises 40% carbohydrates, 35% fat, and 25% protein. In another embodiment, in step (b), balancing comprises 47.5% carbohydrates, 27.5% fat, and 25% protein. In yet another embodiment, in step (b), extra building comprises 35% carbohydrates, 32.5% fat, and 32.5% protein.

In one embodiment, an adjusted weight value based on the weight query value and ideal weight query value is provided, wherein the adjusted weight value is used to generate the Portions Profile. In another embodiment, the adjusted weight value is equal to the current weight query value when the current weight equals the ideal weight query value. In one embodiment, the adjusted weight value is equal to the ideal weight query value when the current weight is within 30 lbs. of the ideal weight query value. In one embodiment, the adjusted weight value is equal to the current weight query value less 30 lbs. when the current weight is greater than 30 lbs. of the ideal weight query value. In one embodiment, the plurality of activity levels may adjust the ideal weight query value. In one embodiment, sedentary does not adjust the ideal weight query value, moderate adjusts the ideal weight query value by an additional 8 lbs., and heavy adjusts the ideal weight query value by an additional 15 lbs. In another embodiment, in step (c), the daily recommended amount of carbohydrates comprises a first subcategory including grain/legume, starchy vegetable, leafy vegetable, crunchy vegetable, fruit, and extra carbohydrates. In yet another embodiment, in step (c), the daily recommended amount of fat comprises a second subcategory including saturated, monounsaturated, omega-3, and omega-6.

In another aspect of the invention, a system is provided, comprising: an Internet-connected computerized appliance having a processor and coupled to a data repository, the processor executing software from a non-transitory medium, the software providing an interactive interface to a Portions Profile system, the system enabling a user to: log on and complete registration; answer a portions profile questionnaire to generate a customized Portions Profile comprising a daily recommend amount of protein, carbohydrates, fats, and fluids to promote metabolic healing; log and track food intake; and compare the food intake to the customized Portions Profile.

### BRIEF DESCRIPTION OF THE SEVERAL VIEWS OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 is an example of a Portions Profile according to an embodiment of the present invention.

FIG. 2 is a flow diagram illustrating how the number of portions in each Portions Profile is selected according to an embodiment of the present invention.

FIG. 3 is a flow diagram illustrating how the number of portions in each Portions Profile is calculated according to an embodiment of the present invention.

FIGS. 4A-B are flow diagrams illustrating the factors that influence the selection of a Portions Profile for an individual user according to an embodiment of the present invention.

FIGS. 5A-C illustrate the structure of the Portions System web application interface that enables a user to enter foods eaten that will be converted to portions and added to the user's Portions Profile according to an embodiment of the present invention.

FIG. 6 is a diagram explaining that Food Categories may affect more than one Portion Category and illustrating which Portion Categories are affected by foods in each Food Category.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The Portions System described herein provides a user with a customized Portions Profile that shows him or her how much of what to eat and in what combinations to effect metabolic healing, and when used in conjunction with a web application interface, enables the user to log and track his or her daily food.

The Portions System provides each user with a customized template showing the number of portions of each type of food to eat over a day, shows the user how to combine his or her portions to create healing meals and snacks, thereby providing a mechanism for eating in a way that effects deep metabolic healing, and is integrated with a web application interface enabling a user to enter food eaten and converting food entered into portions and adding those portions to the user's Portions Profile.

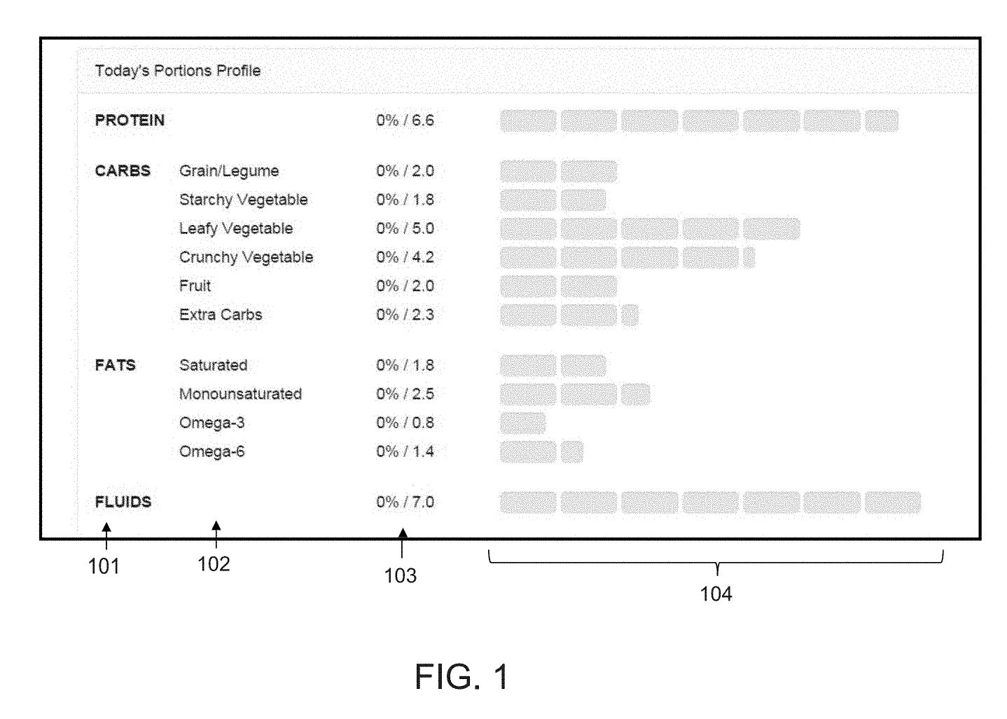

FIG. 1 is an example of a Portions Profile according to an embodiment of the present invention. Portion macro categories 101 include the four main portion categories in the Portions Profile, protein, carbs, fats, and fluids. A portion is a predefined quantity of each type of food. Portion categories 102 are sub-categories within the carbs and fats macro categories that include grain/legume, starchy vegetable, leafy vegetable, crunchy vegetable, fruit, and extra carbs under the carbs macro category, and saturated, monounsaturated, omega-3, and omega-6 under the fats macro category.

In one embodiment, the numbers of daily portions in each category 103 are displayed. This shows the percentage amount of the daily portion consumed in each category, based on predetermined portion values. The predetermined portion values will be discussed in greater detail below. Portion units 103 correspond to the daily number of portions in each portion category. For instance, in the example illustrated, the customized Portions Profile contains 2.0 units of “grain/legume” in the portion category located under the carbs macro category, and these 2.0 units are displayed as two bars. These units are filled in as the user enters his or her food consumption into a web application interface. The details of the software application will be discussed in further detail below.

TABLE 1

| | | Grams | Calories |
|---|---|---|---|
| Portion Macro | | per | per |
| Category | Portion Category | Portion | Portion |
| Protein | Protein | 10 | 100 |
| Carbohydrates | Grain/Legume | 20 | 110 |
| | Starchy Vegetable | 17.5 | 85 |
| | Leafy Vegetable | 5 | 10 |
| | Crunchy Vegetable | 7 | 25 |
| | Fruit | 15 | 60 |
| | Extra Carb | 15 | 75 |
| Fat | Fat (all types) | 9 | 100 |
| Fluids | Fluids | 12 oz. | 0 |

Table 1 above shows how portion values are computed. Portion categories are assigned a portion value based on macronutrient grams. The average number of calories corresponding to the number of grams that define the portion value is determined for each portion category. This information is used to compute the number of portions in each portion category for each Portions Profile.

In one embodiment, there are 42 Portions Profiles in each age category based on metabolic factors. Metabolic factors comprise building, balancing, and extra building. Each metabolic factor has different ratios of macronutrient categories of carbs, proteins, and fats. In one embodiment, building comprises 40% carbs, 35% fat, and 25% protein. In one embodiment, balancing comprises 47.5% carbs, 27.5% fat, and 25% protein. In one embodiment, extra building comprises 35% carbs, 32.5% fat, and 32.5% protein. It is a particular advantage of the present invention that, in additional to metabolic factors, Portions Profiles are based on a user's weight and daily calories. Daily calories for macronutrients categories are computed by multiplying total daily calories by carb/protein/fat ratios. In one embodiment, the daily calories are based on the government dietary guidelines and on recommended calories based on age and physical activity level, sedentary, moderately active, and heavy active. Daily calories for macronutrients categories are computed based on the percentages listed above and calculated as follows:

Macronutrient Carbohydrates=(Daily calories)×(Metabolic factors % Carbs) (1)

Macronutrient Fats=(Daily calories)×(Metabolic factors % Fats) (2)

Macronutrient Protein=(Daily calories)×(Metabolic factors % Protein) (3)

For instance, for a 95 lb person in a 15-25 year old age group with a sedentary physical activity level has a daily recommended calories of 1,950; thus, for building, the macronutrients would be calculated as follows: Macronutrient Carbs=1,950×40%=780; Macronutrient Fats=1,950×35%=682.5; Macronutrient Protein=1,950×25%=487.5.

TABLE 2

| Food Category | Building/ | Extra |
|---|---|---|
| Ratios | Balancing | Building |
| G/L | 0.28 | 0.23 |
| SV | 0.19 | 0.19 |
| Extra | 0.21 | 0.20 |
| Fruit | 0.15 | 0.08 |
| Leafy | 0.06 | 0.10 |
| Crunchy | 0.11 | 0.20 |
| Sat | 0.25 | 0.20 |
| Mono | 0.35 | 0.375 |
| O-3 | 0.16 | 0.18 |
| O-6 | 0.24 | 0.24 |

Daily calories for carbohydrate and fat food subcategories are computed by multiplying macronutrient calories by carbohydrate and fat ratios shown in Table 2. It should be noted that protein does not have food categories.

Daily Calories=(Macronutrient Calories)×(Food Category Ratio) (4)

Using the above example of the 95 lb person for building, the daily calories for Grain/Legume (G/L) would be 780×0.28=218.4. The daily portions for each food subcategory are computed by dividing calories for each food subcategory by calories per portion. For instance, using the same example and utilizing Table 1, the daily portions for Grain/Legume (G/L) would be 218.4/110=2.0, as calculated from the following equation:

Daily portion=(Daily Calories for food category)/(Calories per portion) (5)

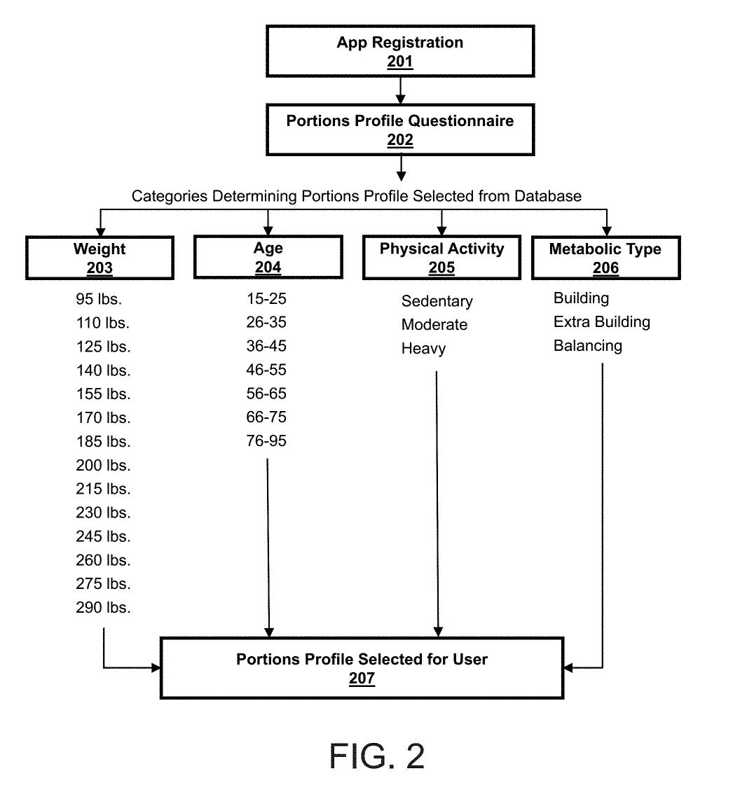

FIG. 2 is a flow diagram illustrating how the number of portions in each Portions Profile are selected according to an embodiment of the present invention. Referring now to FIG. 2, the Portions Profile is based on a number of user queries. First, a user completes the web application registration 201, and is presented with a questionnaire 202 that includes queries for weight 203, age 204, and physical activity 205. The metabolic factor 206, such as building, extra building, or balancing, is determined by queries in the questionnaire. Based on the questionnaire, and the details and examples discussed above, a Portions Profile is selected for the user 207.

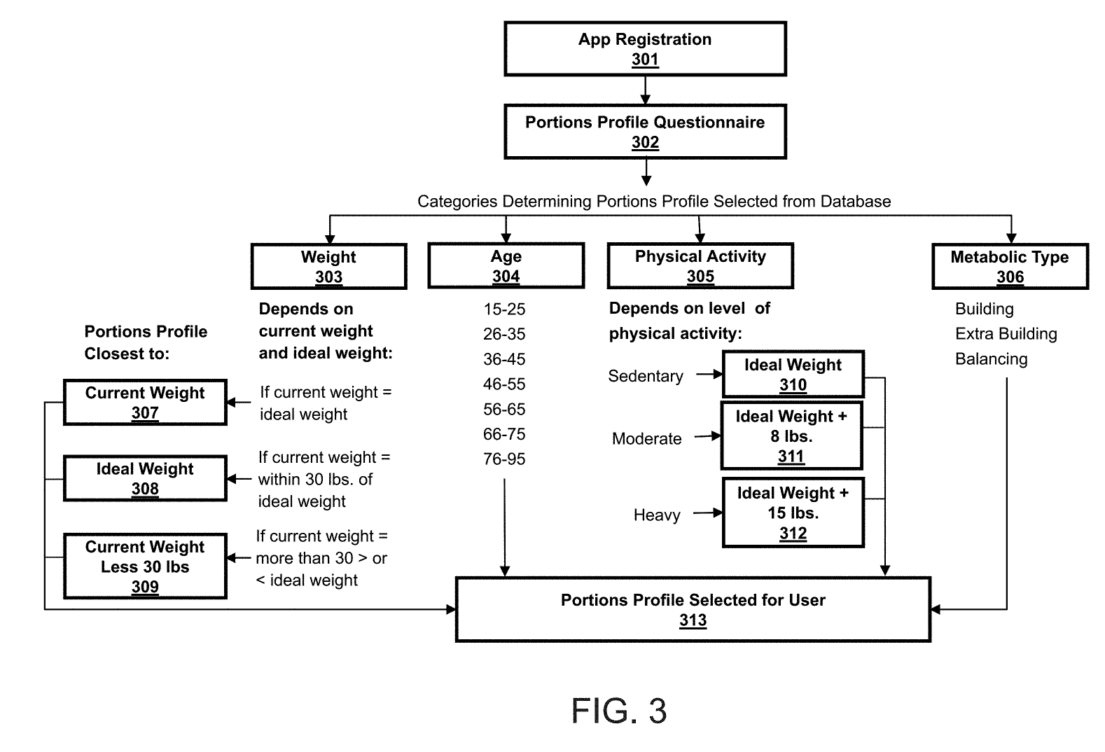

FIG. 3 is a flow diagram illustrating how the number of portions in each Portions Profile is calculated according to an embodiment of the present invention. Referring now to FIG. 3, the Portions Profile is based on a number of user queries. First, a user completes the web application registration 301, and is presented a questionnaire 302, including weight 303, age 304, and physical activity 305. In this embodiment, the weight depends on the user's current and ideal weight. If the current weight equals the ideal weight, the current weight is used 307 to determine the Portions Profile. If the current weight is within 30 lbs. of the ideal weight, the ideal weight is used 308 to determine the Portions Profile. If the current weight is greater than 30 lbs. more than the ideal weight, the current weight less 30 lbs. is used 309 to determine the Portions Profile. Similarly, in this embodiment, the ideal weight used to determine the Portions Profile is also determined by the physical activity level of the user. If the user selects sedentary for the physical activity query, the ideal weight is not adjusted 310. If the user selects moderate for the physical activity query, the ideal weight is adjusted by an additional 8 lbs 311. If the user selects heavy for the physical activity query, the ideal weight is adjusted by an additional 15 lbs 312. The metabolic factor 306, such as building, extra building, or balancing, is determined by the questionnaire. Based on the questionnaire and the details and examples discussed above, a Portions Profile is selected for the user 313.

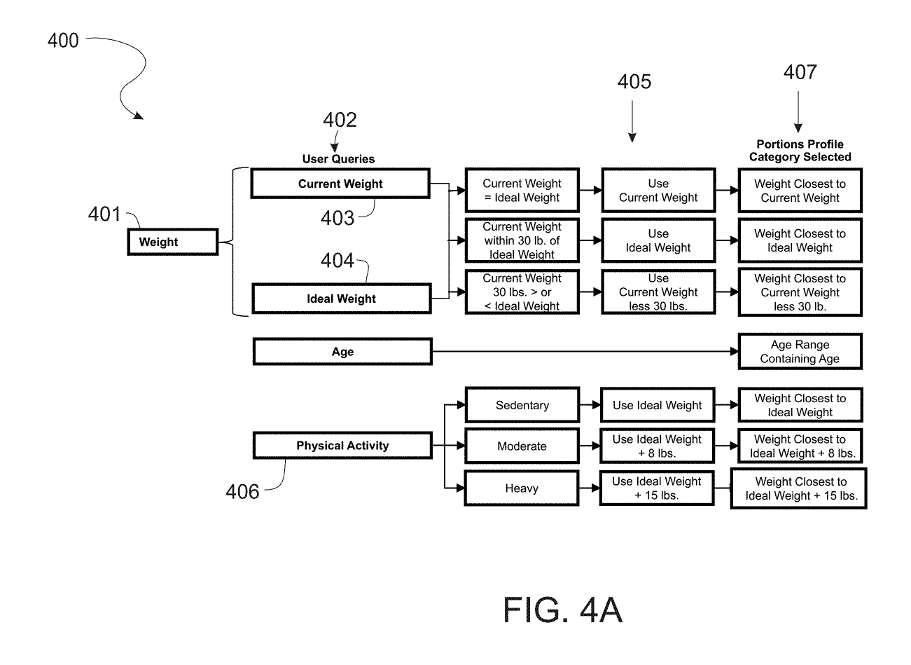

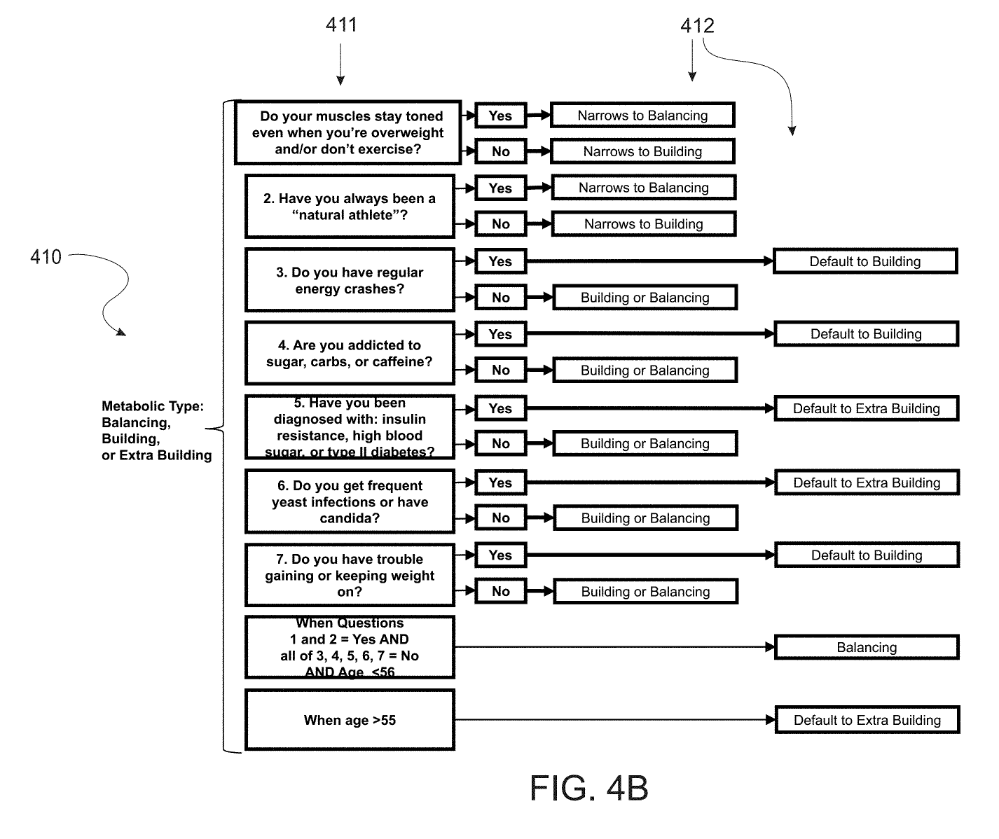

FIGS. 4A-B are flow diagrams 400 and 410, respectively, illustrating the factors that influence the selection of a Portions Profile for an individual user according to an embodiment of the present invention. As previously disclosed, in one embodiment, the weight 401 used to determine the Portions Profile is dependent on user queries 402, and specifically current weight 403 and ideal weight 404. Depending on the relationship between the current weight and ideal weight 405, as well as physical activity 406, the Portions Profile is selected using a specific weight 407, and age based on the user quires. The Portions Profile may be adjusted by a plurality of user queries 411 to determine the metabolic factor 412, either balancing, building, or extra building.

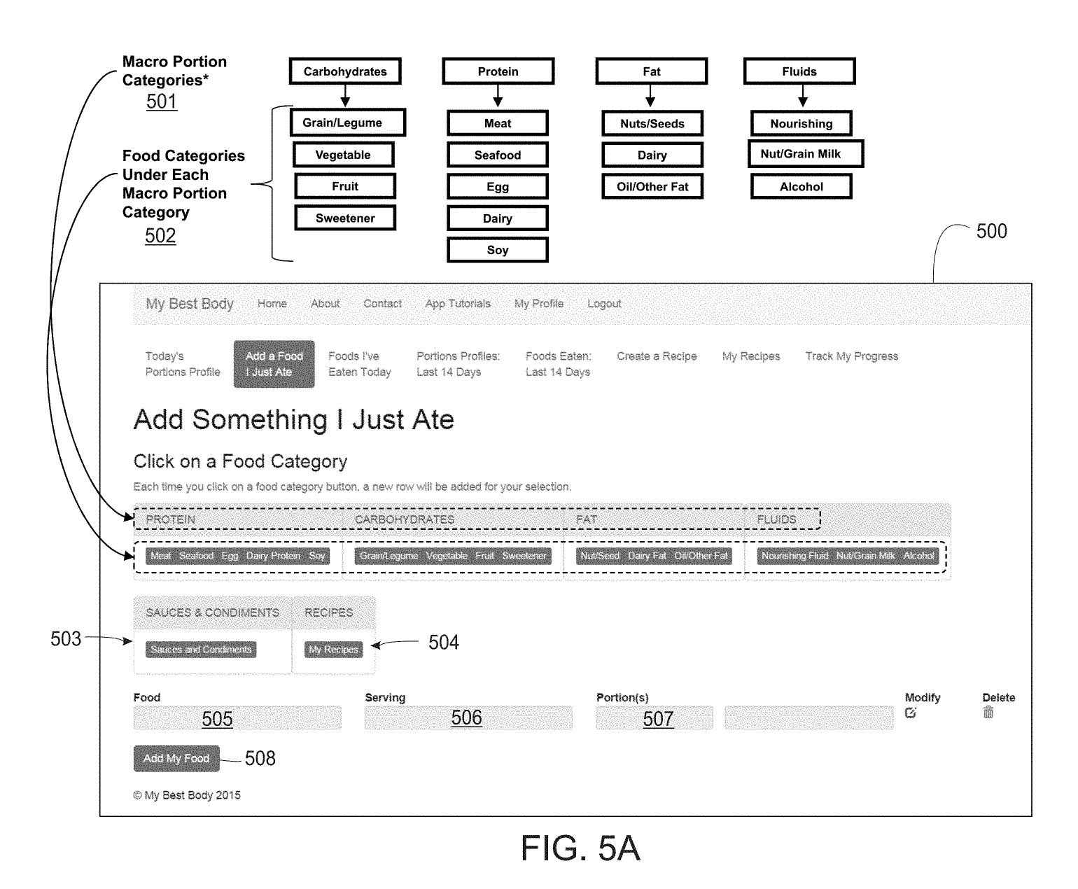

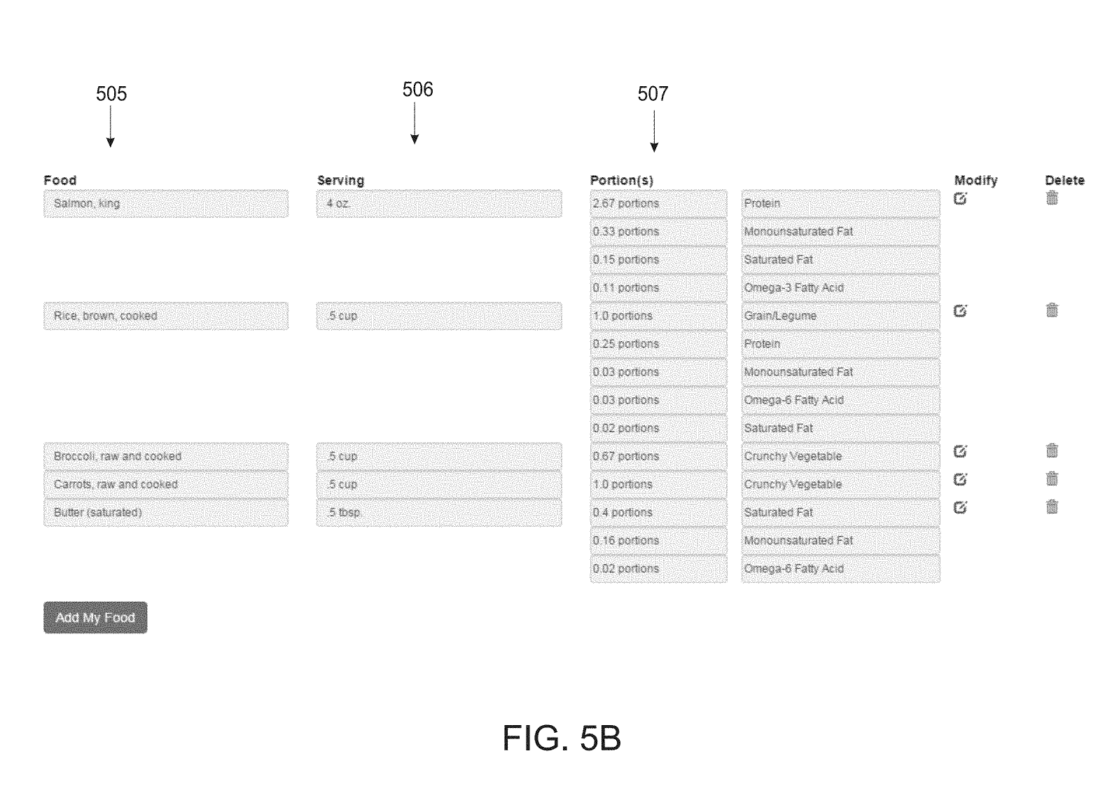

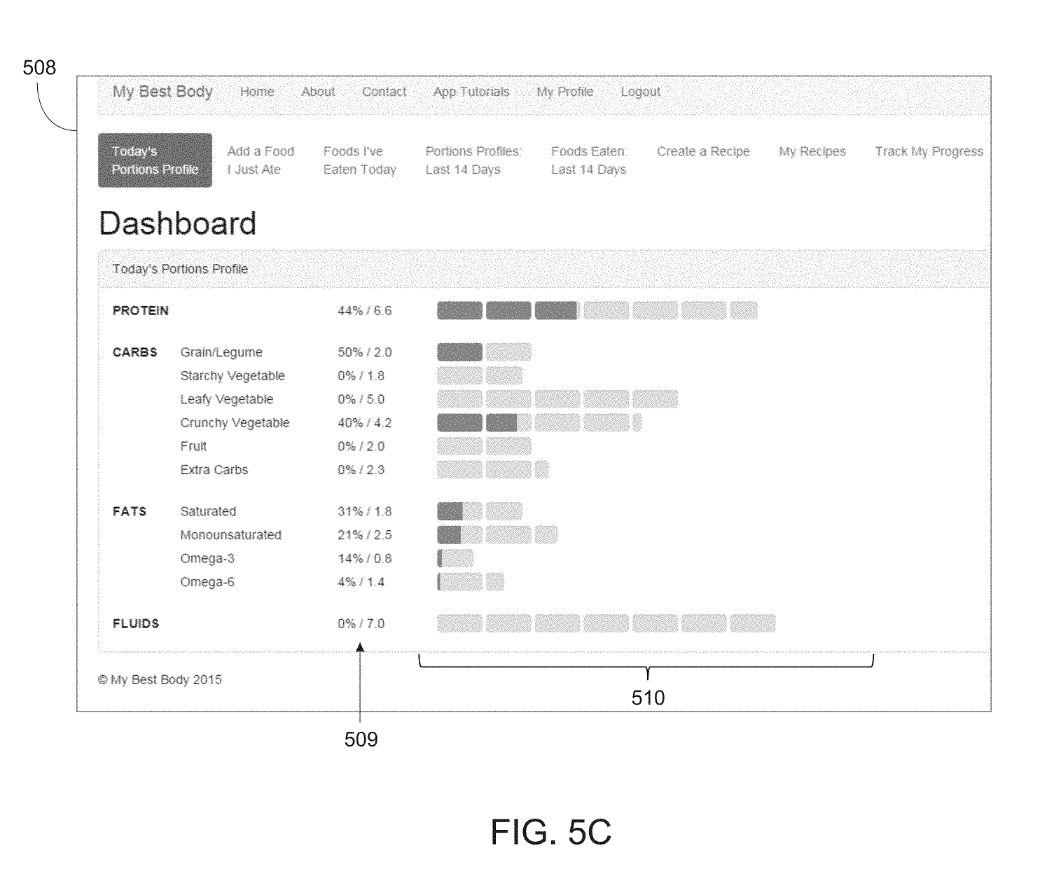

FIGS. 5A-C illustrate the structure of the Portions System web application interface 500 that enables a user to enter foods eaten that will be converted to portions and added to the user's Portions Profile according to an embodiment of the present invention. Referring now to FIGS. 5A-C, the user enters foods based on Macro portion categories 501 and the respective food categories under each Macro portion category 502, as well as sauces and condiments 503. Recipes 504 can be created and saved to streamline the process of adding foods to the web application interface. As foods eaten are entered, they are displayed on the web application interface including food details 505, serving size 506, and the portions 507 of the respective foods. The serving size is the quantity of the specific food the user eats in one sitting, which may be more or less than a portion of the food. Once the food is added using the web application interface, the Portions Profile 508 user dashboard is updated, and the portion units 509, 510 are filled. The is a particular advantage of the present invention, as the portion units 510 visually show the user what has been eaten, and what should be eaten to achieve his or her desired goals.

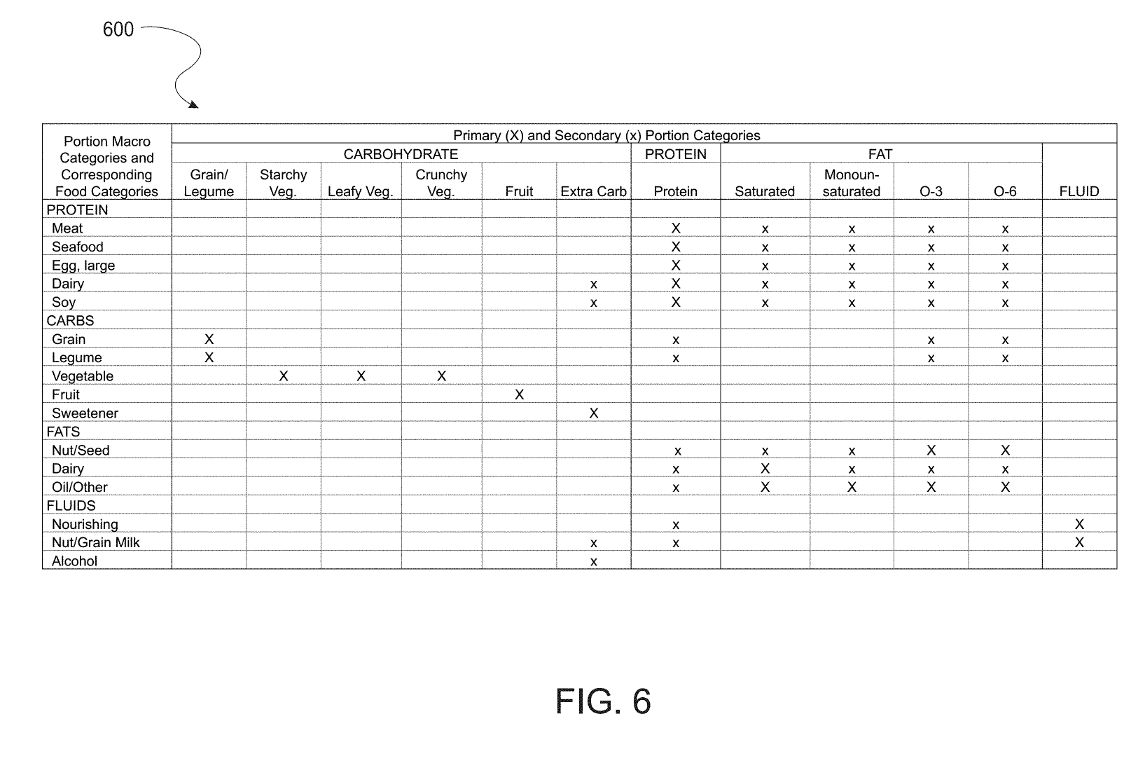

FIG. 6 is a diagram 600 explaining that Food Categories may affect more than one Portion Category and illustrating which Portion Categories are affected by foods in each Food Category. For instance, Legumes affect the Grain/Legume Carb Portion Category, as well as the Protein category, and the Omega-3 and Omega-6 Fat Portion Categories.

The present invention is a radical departure from other electronic food logging and tracking systems. Virtually all electronic food logging and tracking plans are based on a calorie orientation and are designed for weight management. Thus, in response to a brief user query (usually one or two questions relating to the user's weight and height), these programs tell the user how many daily calories to eat to reach his or her weight goal or maintain his or her current weight and provide a user interface for recording and tracking the user's daily food. The user is then focused solely on eating such that he or she meets his or her daily calorie goal without attention to food quality, the variety of foods eaten, or how the foods eaten are combined in each meal or snack (i.e., the balance of the meal or snack). Calorie-oriented food tracking programs also often provide a food database for the user to look up and select foods he or she has eaten that contain low-calorie, low-fat, fat-free, or other low-quality prepackaged foods, implying to the user that such foods are part of a healthy diet when they are not. In contrast, the Portions System is based on a portions orientation and is designed for deep metabolic healing and the healing of or improvement in symptoms of metabolic damage.

The Portions System selects a Portions Profile from a database of 336 Portions Profiles based on the user's age, current weight, ideal weight, physical activity, and general metabolic health, the latter ascertained through a probing 10-question questionnaire.

The user's Portions Profile provides a specific number of portions in 12 food categories designed to maximize the variety of nutrients (vitamins, minerals, phytonutrients, and fiber) from the foods he or she eats.

The web application interface teaches the user how to mix and match the portions in his or her Portions Profile to create balanced meals and snacks that have a low-glycemic load. Studies have shown that a low-glycemic diet may induce favorable metabolic effects.

The Portions System food database used to find and select foods eaten by the user contains whole foods only and reinforces proper food quality standards to the user.

The techniques and process herein provide several novel characteristics not limited to a Customized Portions Profile, including a guide on what to eat to activate metabolic healing and eliminate or decrease metabolic symptoms, and a web application interface that selects a Portions Profile based on user queries and enables progress and meal tracking.

In some embodiments, the methods, systems, and devices described herein may be implemented on a web-browser and web server system, or on a remote internet server that provides data to web browsers or apps running on smartphones, wrist-mounted computerized devices (e.g. Apple iWatch and equivalent), tablet computers, or other computerized devices.

In some embodiments, the web server may provide web pages or app data to remote computerized systems running web browsers or apps operated by remote users. The remote users may enter the user-specific data into their web browsers or apps, and the calculation load to implement the various algorithms described herein may be portioned between the web browsers/apps and the web servers as desired.

In other embodiments, the methods, systems, and devices described herein may be implemented as stand-alone programs or apps which may implement some or all of the various algorithms described herein.

In some embodiments, such as where the method is implemented on personally worn computerized devices, such as wrist-mounted computerized devices, or certain types of smartphone configurations, it may be useful to further monitor accelerometer data from the computerized devices to look for patterns of user motion consistent with eating, for example a repetitive motion such as might be associated with eating with utensils and the like. The devices may be further programmed to then prompt the user to enter in portion types and amounts when or soon after such eating associated motion is detected.

Alternatively or additionally, the methods described herein may also either automatically, or with user input, keep track of the user's body motion throughout the day (e.g. keep track of number of paces, and the like) and may adjust the user's nutritional needs up or down according to the amount of exercise that the user is estimated to have performed that day.

In other embodiments, the method may be implemented to prompt the user to take photographs of meals prior to eating. The method may then use automated vision recognition methods to at least partially fill in the various portion fields for that meal, and/or to double-check the user's entry of portion fields for that meal.

To assist in more accurately estimating nutritional content of either packaged foods or custom recipes, those computerized devices equipped with cameras may also be configured to take photographs of the UPC bar codes associated with the foods. The system may then correlate the bar codes with a database of nutritional compositions of the associated foods and allow the user the option to accept entries from this bar-coded database of nutritional compositions into the system.

To encourage user compliance, at least portable versions of the system may also be configured with the user's typical meal schedule, and may be configured to then remind the user to input data according to the user's typical schedule.

In other embodiments, the method may be implemented to enable a user to create daily menu plans consisting of meals and snacks that utilize the user's daily portions, and automatically generate a shopping list of the ingredients comprising the menu plans.

Although in some embodiments, the methods and devices described herein may be encoded into software, and then run on standard microprocessors, such as the popular ARM, x86, MIPS, MPSP430 series of microprocessors, in other embodiments, more specialized electronic circuits may be used. For example, custom integrated circuits with hardware dedicated only for the algorithms described herein, or field programmable gate arrays (FPGA) may also be used.

In other embodiments, the method may be implemented, provided, delivered, or in any other way conveyed to a user by way of book; mail-order paper system; manual or mechanical methodology, group setting such as class, seminar, workshop, and so forth; or any other electronic or non-online method.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A process, comprising steps:
(a) providing a list of user queries to a user, wherein the list of user queries includes a weight query, an age query, and a physical activity query, wherein the physical activity query comprises a plurality of activity levels including sedentary, moderate, and heavy;
(b) determining a metabolic factor based on the list of user queries, wherein the metabolic factor comprises building, balancing, and extra building, each having a different ratio of macronutrient categories of carbohydrates, proteins, and fats; and
(c) generating a portions profile based on the list of user queries and the metabolic factor, wherein the portions profile comprises a number of portion macro-categories consisting of a protein macro-category, a carbohydrates macro-categorey, a fats macro-category, and a fluids macro-category, wherein the carbohydrates macro-category includes a first number of portion sub-categories and the fats macro-category includes a second number of portion sub-categories, wherein the first number of portion sub-category includes a grain/legume category, a starchy vegetable category, a leafy vegetable category, a crunchy vegetable category, a fruit category, and an extra carbs category; wherein the second number of portion sub-categories includes a saturated category, a monounsaturated category, an omega-3 category, and an omega-6 category; wherein the protein macro-category and the fluids macro-category, the first number of portion sub-categories, and the second number of portion sub-categories are represented by a plurality of portion values corresponding to a daily recommended amount of protein, carbohydrates, fats, and fluids to be consumed by the user to promote metabolic healing; and
(d)filling in a percentage of the plurality of portion values corresponding to a meal via a filling means.

2. The process of claim 1, wherein in step (a), the weight query includes a current weight query value and an ideal weight query value.

3. The process of claim 1, wherein in step (b), building comprises 40% carbohydrates, 35% fat, and 25% protein.

4. The process of claim 1, wherein in step (b), balancing comprises 47.5% carbohydrates, 27.5% fat, and 25% protein.

5. The process of claim 1, wherein in step (b), extra building comprises 35% carbohydrates, 32.5% fat, and 32.5% protein.

6. The process of claim 2, further comprising an adjusted weight value based on the current weight query value and the ideal weight query value, wherein the adjusted weight value is used to generate the portions profile.

7. The process of claim 6, wherein the adjusted weight value is equal to the current weight query value when the current weight query value equals the ideal weight query value.

8. The process of claim 6, wherein the adjusted weight value is equal to the ideal weight query value when the current weight query value is within 30 lbs of the ideal weight query value.

9. The process of claim 6, wherein the adjusted weight value is equal to the current weight query value less 30 lbs when the current weight query value is greater than 30 lbs of the ideal weight query value.

10. The process of claim 6, wherein the plurality of activity levels may adjust the ideal weight query value.

11. The process of claim 10, wherein sedentary does not adjust the ideal weight query value, moderate adjusts the ideal weight query value by an additional 8 lbs, and heavy adjusts the ideal weight query value by an additional 15 lbs.

12. (canceled)

13. (canceled)

14. A system comprising:
an Internet-connected computerized appliance having a processor and coupled to a data repository, the processor executing software from a non-transitory medium, the software providing an interactive interface to portions profile system, the system enabling a user to:
log on and complete registration;
answer a portions profile questionnaire to generate a customized portions profile comprising a number of portion macro-categories consisting of a protein macro-category, a carbohydrates macro-category, a fats macro-category, and a fluids macro-category, wherein the carbohydrates macro-category includes a first number of portion sub-categories and the fats macro-category includes a second number of portion sub-categories; wherein the first number of portion sub-category includes a grain/legume category, a starchy vegetable category, a leafy vegetable category, a crunchy vegetable category, a fruit category, and an extra carbs category; wherein the second number of portion sub-categories includes a saturated category, a monounsaturated category, an omega-3 category, and an omega-6 category; wherein the protein macro-category and the fluids macro-category, the first number of portion sub-categories, and the second number of portion sub-categories are represented by a plurality of portion values corresponding to a daily recommended amount of protein, carbohydrates, fats, and fluids to promote metabolic healing; and
log and track food intake by filling in a percentage of the plurality of portion values corresponding to a meal via a meal tracking means.

15. The system of claim 14, wherein the meal tracking means is via a photograph of the meal and wherein the photograph is used with an automated vision recognition method.

16. The system of claim 14, wherein the meal tracking means is via a photograph of a UPC bar code provided on the meal using a computerized device having a camera, wherein the UPC bar code is correlated to a database of nutritional compositions of food.

17. The process of claim 1, further comprising a step (e) wherein step (d) is repeated for all food items and/or other meals eaten by the user.

18. The process of claim 1, wherein in step (d), the filling means is via a web application interface.

19. The process of claim 1, wherein in step (d), the filling means is via a photograph of the meal.

20. The process of claim 19, wherein the photograph is used with an automated vision recognition method.

21. The process of claim 1, wherein in step (d), the filling means is via a photograph of a UPC bar code provided on the meal using a computerized device having a camera, wherein the UPC bar code is correlated to a database of nutritional compositions of food.

22. The process of claim 1, wherein the process is provided via a mail-order paper system.
